(19) United States
(12) Patent Application Publication
(10) Pub. No.: US 2002/0026630 A1
(43) Pub. Date: Feb. 28, 2002

(54) Enterprise application integration methodology

(76) Inventors: John Schmidt, Minnetonka, MN (US); Anne Morrison, Falls Church, VA (US); Erik Roland Gruneus, Fairfax, VA (US)

Correspondence Address: STAAS & HALSEY LLP, 700 11TH STREET, NW, SUITE 500, WASHINGTON, DC, 20001, US

(21) Appl. No.: 09/824,690

(22) Filed: Apr. 4, 2001

Related U.S. Application Data
(60) Provisional application No. 60/227,908, filed on Aug. 28, 2000.

(51) Int. Cl. G06F 9/44

(52) U.S. Cl. 717/103

(57) ABSTRACT

A method for integrating business functions performed by different application systems comprising generating a business model, based upon said application systems, generating a logical model, based upon said business model, generating a physical model, based upon said logical model, designing an infrastructure, based upon said physical model, assembling the infrastructure, testing the infrastructure, and implementing the infrastructure.

### CROSS REFERENCE TO RELATED APPLICATION

This application is related to U.S. application entitled Enterprise Application Integration Methodology, having Ser. No. 60/227,908, filed Aug. 28, 2000 and incorporated by reference herein.

### BACKGROUND OF THE INVENTION

1. Field of the Invention

The present invention is related to Enterprise Application Integration (EAI). More particularly, the present invention is related to a methodology for EAI implementation.

2. Description of the Related Art

Application software generally provides functions that directly support part of an enterprise's business processes. Application software may be an off-the-shelf package or it may be custom-built. Applications may be part of an organization's legacy systems, or may be new to the organization. Application integration is the process of making these various applications work together.

Enterprise Application Integration, hereinafter referred to as “EAI”, is a term used in industry to refer to application integration on a broad scale across an enterprise. EAI refers to the challenge of efficiently linking together many different systems, databases, and applications across an enterprise in a way that allows organizations to keep up with the accelerating pace of change in the marketplace.

There are many established techniques for integrating systems. However, the term EAI is normally used when referring to one specific type of integration characterized by the use of a set of special tools called “middleware”. EAI tools consist of commercial, off-the-shelf software specifically designed to bridge applications. Alternately, consulting firms may be hired by an enterprise to custom program middleware to integrate the enterprise's systems and applications.

Existing EAI implementations are point solutions designed to solve a particular problem. For example, a particular EAI point solution may try and solve the problem of tying a web interface directly to an order system within an enterprise so that customers of the enterprise may perform their own ordering. Problems exist with traditional EAI implementations, because existing EAI solutions solve these types of “point” problems only, without regard to the future, and without a methodology to modify and/or expand the point solution as needs arise.

Further, problems arise with existing EAI implementations because the following questions are not addressed by existing EAI implementations: what is needed after the initial EAI implementation, what happens once the EAI project is implemented, how is the EAI project maintained, how does the EAI project change and evolve over time, and how can the EAI project be expanded to include other applications and/or systems? Therefore, a need exists for an EAI methodology for implementing EAI solutions that address the above-mentioned questions.

Further, due to the myriad combinations of existing software and middleware solutions, every EAI project is different and presents a unique new challenge. Thus, a need exists for an EAI methodology to implement EAI solutions that provides consistency, and yet is flexible enough to be adaptable to each project.

### SUMMARY OF THE INVENTION

It is an object of the present invention to provide an enterprise application integration methodology for integrating enterprise application systems.

It is another object of the present invention to provide an enterprise application integration methodology for maintaining enterprise application systems.

It is a further object of the present invention to provide an enterprise application integration methodology for expanding enterprise application systems.

It is yet another object of the present invention to provide an enterprise application integration methodology for modifying enterprise application systems.

The above objects can be attained by a method for integrating application systems, comprising generating a business model, based upon said application systems, generating a logical model, based upon said business model, generating a physical model, based upon said logical model, designing an infrastructure, based upon said physical model, assembling the infrastructure, testing the infrastructure; and implementing the infrastructure.

These together with other objects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows an application integration maturity model according to the present invention.

FIG. 2 shows an integration framework serving the basis for a repeatable EAI lifecycle methodology according to the present invention.

FIG. 3 shows EAI methodology phases, activity areas and activities, according to the present invention.

### DESCRIPTION OF THE PREFERRED EMBODIMENTS

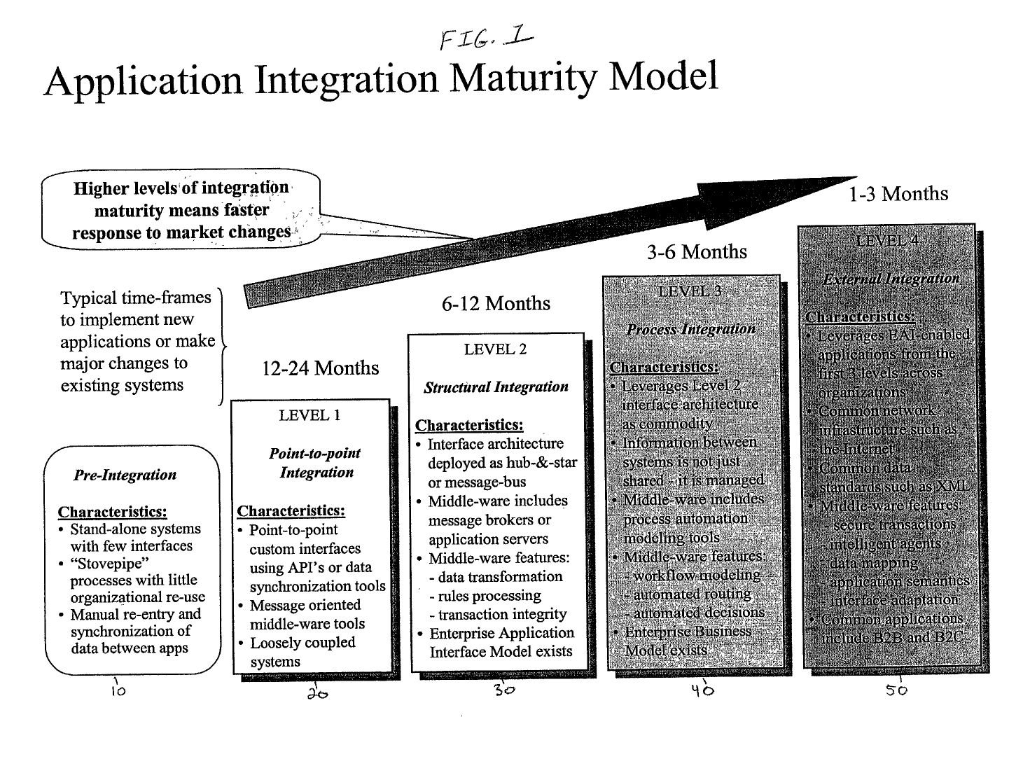

FIG. 1 shows an application integration maturity model according to the present invention. At Pre-integration stage 10, whose characteristics include stand-alone systems and manual re-entry and synchronization of data between applications, no application integration has yet occurred.

Point-to-point integration stage 20, whose characteristic include point-to-point custom interfaces between applications using Application Programming Interfaces (APIs) or data synchronization tools, is the predominant form of how application integration is practiced. For example, point-to-point integration includes systems that communicate with one another through hard coded interfaces. The business rules or logic associated with the interaction between the systems is an integral part of the custom hard coded interface.

At structural integration stage 30, the business logic and business rules associated with the interaction between systems are integrated into a central framework. Thus, the rules about the interaction between systems is stored centrally. The interfaces between applications send all of their data to one particular hub source, and the rules about where the data is forwarded to is stored in that hub.

At process integration stage 40, a business process model provides process steps which must occur for a business process to occur. Stage 40 provides a way to model business processes and provide a direct linkage with underlying systems.

At external integration stage 50, EAI-enabled applications from stages 20, 30, and 40 are leveraged outside the enterprise, to the supply chain.

This present invention provides the method and approach for achieving structural integration stage 30, and for achieving process integration stage 40, and how to transition from stage 30 to stage 40.

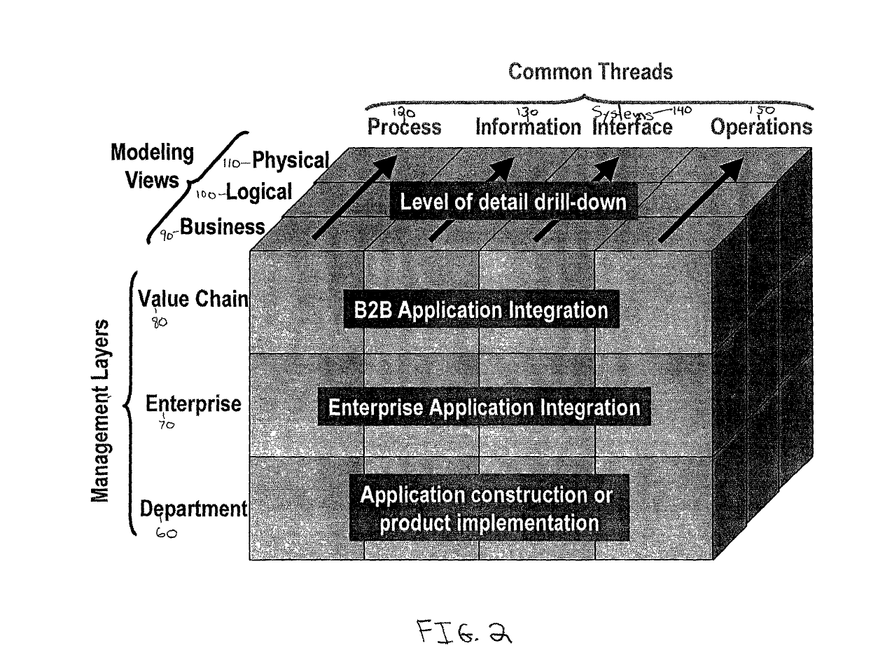

FIG. 2 shows an integration framework serving the basis for a repeatable EAI lifecycle methodology according to the present invention. There are four key principles behind the formulation of the framework: breaking down complexity into manageable pieces, the importance of an enterprise architecture, integration versus construction, and lifecycle management and change.

The massive complexity of integrating an entire worldwide supply chain is too detailed to deal with in its entirety. Therefore, the problem is divided into smaller pieces along three dimensions: 1) three management layers called department 60, enterprise 70, and value (or supply) chain 80, 2) four subject threads called process 120, information 130, systems interface 140, and operations 150 and 3) three modeling views, showing different levels of detail called business 90, logical 100, and physical 110 (business modeling view 90 is the broadest view; logical modeling view 100 is a more detailed view; while physical modeling view 110 the most detailed view).

These three dimensions provide a structured way to break down the problem space into 36 discrete models that can describe the entire end-to-end integrated solution. In order to effectively describe the solution, each model focuses only on the specific cross-section of the three dimensions using, where possible, highly graphical documentation techniques. There are many instances of each model to reflect the specifics of each department, enterprise, and value chain. However, the advantage of this model is that by having a consistent way to break down the problem, it becomes possible to have different groups and individuals working on different parts of the integrated solution with minimal duplication of effort and with minimal gaps.

The present invention focuses primarily at the middle layer (enterprise 70).

An enterprise-wide architecture should be considered an input to any EAI initiative—if it does not exist, the eArchitecture component of AMS ePractices should be followed to develop one. Architecture exists across all three dimensions of the framework and defines the underlying constraints, including standards and rules, that any solution addressing that dimension must follow. Most enterprises have architectural standards, and many supply chains have such standards or are attempting to develop them through various associations and standards bodies.

Another input, apart from the architecture, may be a business process model that shows how the enterprise is planning to execute its business. Such a business process model may, for example, include the activities performed by a person taking an order. Such order taking activities include, for example, order entry, checking service availability, checking the availability of resources to perform installation, performing a credit check, and sending an order to provisioning.

The models produced as part of an EAI initiative are also enterprise-wide in scope, building on the enterprise-wide architecture. These EAI models are abstract representations of a specific dimension of a real world solution, either as it currently exists or as it will be implemented.

It is important to keep in mind that while architecture is mainly an input to an EAI project, it may also be affected by EAI. A specific EAI initiative may require a change to an existing architecture, hence the importance of using the Engagement Management Framework® (EMF) in mind to manage dependencies between the different teams involved in integration.

Construction is the process of creating application functions while integration is the process of linking together existing functions. That is, construction is creating the building blocks while integration is assembling them. This distinction is important, because they use different processes, and different staff members with different skills may be needed to do the work. While subtle, the distinction is important; it is often difficult to draw the line between one and the other.

One way to clarify the distinction is to ask the following questions: do business rules for the application functions within the defined problem domain exist; where are the business rules implemented? If business rules do not exist or exist only on paper or in a manual function which would be beneficial to automate, then the solution probably involves a construction lifecycle process using a traditional application development lifecycle. This lifecycle starts with the definition of business needs and definition of requirements. Alternatively, if business rules are already embodied within an application, and a goal is to eliminate the manual effort of duplicate data entry or to implement real-time transfer of data from one system to another, then the solution is strictly an integration lifecycle process. The difference is that in an integration-only process, requirements are not needed; rather, specifications of the functions to be integrated are needed, and integration principles are needed that define the objective and help to resolve conflicting business rules.

The problem of keeping these two activities separate and distinct is even more complicated when considering the situation of establishing new business rules that are result directly from an integration effort. The first question to ask in this situation is where the new functionality should be implemented. There are three possibilities:

In an existing application (for example, modify a legacy system), which involves a reengineering effort.

In a new application (for example, a customer management system that consolidates and controls other applications), which involves an eCycle application implementation effort.

In the middleware layer itself (for example, implementing a customer domain object model within the middleware software agents), which involves a software engineering effort as an integral part of the middleware infrastructure development.

All three options have pros and cons that are unique to each situation. Application development generally occurs at the departmental layer and integration activities generally occur at the enterprise level. The important point is that this should be an informed, engagement-level decision.

While the processes for integration and construction are different, it is not necessarily the best approach to have separate teams do the integration and construction work. In many cases, however, it does make sense to have the activities done separately. This should be a conscious, engagement-level decision based on the circumstances.

Just as applications within a department have a lifecycle and need to be managed throughout their various phases, the middleware layer also has a lifecycle that needs to be managed. The models that represent the enterprise layer, just like maps of a city, must be maintained and constantly updated. The models are living documents that should reflect the current state of the integrated environment at all times. The tools to support the models are still evolving and are clearly less than ideal at present, so this activity still requires a significant manual effort.

There are several aspects of change to consider in the context of EAI and the full lifecycle:

(a) How is change driven through the 36 different models in a controlled manner?

(b) What are the typical drivers of change to an EAI infrastructure?

(c) What are the typical changes that may be the result of an EAI initiative?

The answer to (a), at least at a conceptual level, is that change must be driven from the business level down to the logical and physical levels. Furthermore, it must be driven from the enterprise layer—down to the departments and out to the supply chain. Finally, within each layer, change should generally be driven from the process thread through the information, systems, and operations threads. Throughout all of this, it is critical to maintain a feedback loop so that needs at the departmental level and the dynamics of the supply chain result in the necessary changes being driven at the enterprise level.

The answer to (b) includes the following typical drivers of change:

The need for a new business application or an upgrade or change to a legacy application.

Reengineered business processes as a result of an organization development or change management (OD/CM) effort or a similar initiative intended to automate or streamline processes between systems or organizations.

A new enterprise architecture, which may involve new infrastructure standards.

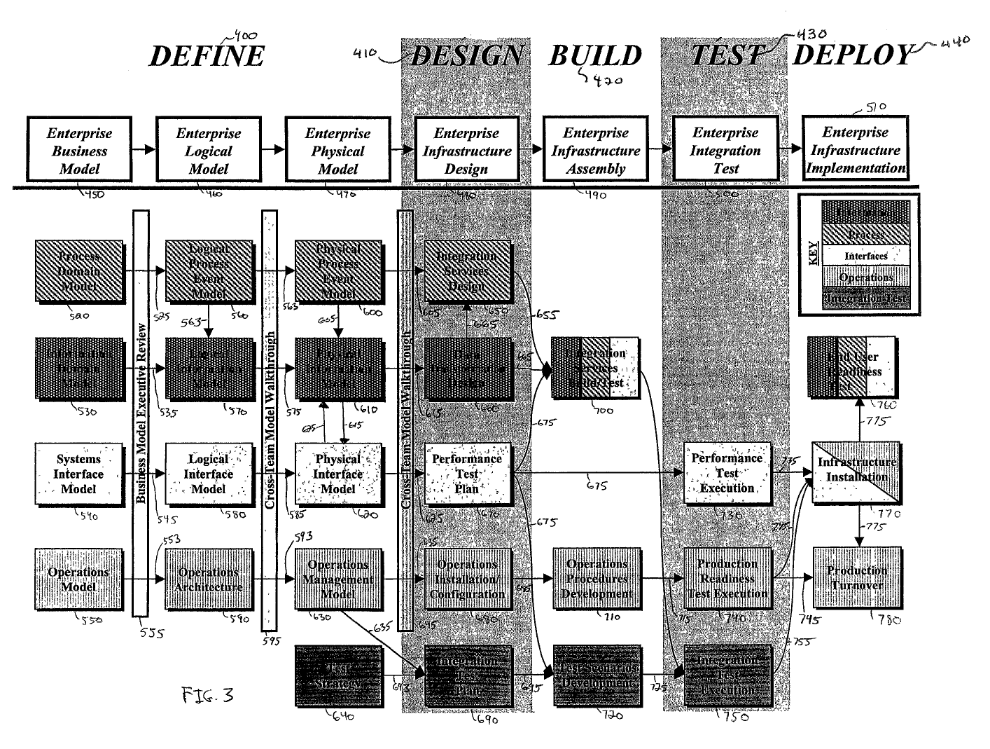

FIG. 3 shows EAI phases, activity areas and activities according to the present invention. As shown in FIG. 3, the EAI methodology of the present invention consists of five main phases: define phase 400, design phase 410, build phase 420, test phase 420, and deploy phase 440.

In the EAI methodology, define phase 400 is associated with enterprise business model activity area 450, enterprise logical model activity area 460, and enterprise physical model activity area 470; design phase 410 is associated with enterprise infrastructure design activity area 480; build phase 420 is associated with enterprise infrastructure assembly activity area 490; test phase 420 is associated with enterprise integration activity area 500; and deploy phase 440 is associated with enterprise infrastructure implementation activity area 510.

Activity areas 450, 460, 470, 480, 490, 500, and 510 maybe performed during a first or subsequent enterprise-wide EAI effort in an organization. During a subsequent EAI effort, such as one that only involves integrating a single new commercial off-the-shelf application, each activity area is typically shorter and less difficult. For example, existing models can be updated rather than built from scratch and the only setup or programming required would involve the interfaces between any new applications and the middleware.

Each activity area comprises a number of activities which may be performed within their corresponding parent activity areas. For example, enterprise business model activity area comprises process domain model activity 520, information domain model activity 530, systems interface model activity 540, operations model activity 550, and Business Model Executive Review 555; enterprise logical model activity area 460 comprises logical process event model activity 560, logical information model activity 570, logical interface model activity 580, operations architecture activity 590, and Cross-Team Model Walkthrough activity 595; enterprise physical model activity area 470 comprises physical process event model activity 600, physical information model activity 610, physical interface model activity 620, operations management model activity 630, test strategy model activity 640, and Cross-Team Model Walkthrough activity 645; enterprise infrastructure design activity area 480 comprises integration services design activity 650, data transformation design activity 660, performance test plan activity 670, operations installation/configuration activity 680, and test plan activity 690; enterprise infrastructure assembly activity area comprises build/test integration services activity 700, develop operations procedures activity 710, and test scenarios activity 720; enterprise integration test activity area 500 comprises performance test execution activity 730, production readiness test execution activity 740, and integration test execution activity 750; enterprise infrastructure implementation activity area comprises end user readiness test activity 760, infrastructure installation activity 770, and production turnover activity 780. Each of the activity areas and their corresponding activities are described in detail below.

Enterprise business model activity area 450 is typically the first activity area in an EAI project. Enterprise business model activity area 450 is part of define phase 400. As part of activity area 450, an organization's application systems are modeled from various aspects, at a conceptual level. The purpose of these models is to show the high-level view of the various systems and how they interact. Both the existing (Aas-is@) and proposed (Ato-be@) states may be modeled.

The enterprise business models are typically very brief. Each model consists of a one-page highly graphical diagram with supporting details as needed. Enterprise business models are meant to be understood by top-level managers or executives, such as CEOs, CIOs, and CFOs.

Further, in activity area 450, the organization's key business policies, as they relate to the integration infrastructure, are articulated. These policies, called principles, are used throughout the project to help prioritize options and resolve conflicts or issues.

The general process for developing each of models in activity area 450 is:

(1) Identify the problem domain or scope

(2) Develop the as-is model (which can be thought of as a mapping exercise)

(3) Plan the to-be model

(4) Identify integration principles associated with changing from the existing to the proposed state, and

(5) Perform a cross-team review and obtain senior management approval.

These five operations are usually parallel and iterative activities, as opposed to sequential discrete activities. For example, if the project team member requires several meetings with a stakeholder, the team member would typically discuss the existing state, the future state and the integration issues at each of the meetings, first at a high level and iterating the level of detail at each subsequent meeting until the models are complete.

It is not always necessary to create an as-is model. Because the client knows the current environment well, they may not want to spend much effort on modeling it, focusing instead on the to-be model. Nonetheless there may be value in developing the as-is model, particularly for the team members who may not be familiar with the organization. This is a judgement call that the team lead should make in conjunction with the engagement manager and the client.

It is also common for the scope (problem domain) of the integration initiative to change as part of this activity area. While the client may have a very clear definition of scope when starting the activity area, some issues or opportunities that surface during the as-is/to-be modeling may force a re-evaluation of scope. In other cases, the client may have only a vague notion of the scope and is in fact using the business modeling activity area to clarify and define the appropriate project scope.

The purpose of documenting the integration principles at activity area 450 is to resolve difficult, and often political, issues early in the project. The idea is not to document all of an organization's policies, but rather just those that could cause the project to slow down or create conflict due to differences of opinions or views. For this reason, integration principles will vary greatly between organizations and from one project to the next. For example, having a single enterprise-wide process owner may be a big political issue for the EAI project; thus this should clearly be a principle. But once this role is firmly established and institutionalized in an organization, it is no longer necessary to document it as a principle for subsequent EAI projects.

To decide what integration principles are needed, it is necessary to identify potential issues early. The primary technique for identifying these issues is to interview the senior executives and key stakeholders and ask a series of pointed questions. These questions should cover areas in which there is typically quite a lot of disconnect. If consistent answers are given by everyone to a certain question, then there is no need to document it as a principle. (It may, however, be helpful to document the areas of consensus for the purpose of helping new project team members become aware of the organizational norms). If opposing views are voiced or no views are revealed (i.e., an area that the organization has not dealt with at all), then these are the candidates for further in-depth probing and analysis.

If the organization has ample time and money, a separate consulting engagement could be launched to resolve the identified issues. The Engagement Management Framework® (EMF) decision analysis process also provides useful guidance on how to handle difficult issues. One approach is to try to get to a quick decision by simply making a judgment call, based on prior experience and all the client input, on what the principles should be, and prepare a proposed set of principles. The principles should be intentionally worded in very precise black-and-white terms that focus on the heart of the disagreement. In other words, the principles should be intentionally controversial; if they're not, then it's not an issue for discussion. Once the proposed principles are drafted, then a meeting should be called with all the senior executives and stakeholders for the purpose of discussing, modifying if necessary, and agreeing to the principles. Someone who can be a tie-breaker (e.g.the CEO or CIO) should be present in the meeting.

Enterprise process domain model activity 520 is an organization's key business processes at the conceptual level, along with the Key Process Areas (KPAs) in each of the domains. The purpose of activity 520 is to determine: the categories of process domains that are strategic and should be managed at the enterprise level; the internal and external KPAs included in each of the process domains; the organizational group or individual responsible for each of the process domains; and the mechanisms to be used to keep the processes across the various domains synchronized.

Processes within an enterprise need to be managed at the enterprise level. A critical aspect of activity area 520 is to be selective about the KPAs that should be managed at the corporate level. For example, many departmental workflow process steps do not need to be managed at the enterprise level; only when the process activities cross system or organizational boundaries do they become candidates for consideration.

A KPA is a categorization of major functions and may correspond to departments, department-specific systems, or external units. For example, the Customer Management domain may include KPAs such as contact management, account management, servicing, marketing, churn management, and collections, among others. Alternately, the Financial Management domain may include KPAs such as invoicing, purchasing, accounts receivable, account payable, general ledger accounting, tax reporting, budgeting, and collections.

Note that in two above examples, the “collections” KPA is listed in both the Customer Management and Financial Management process domains. Some organizations may consider it part of the financial management process while others consider it to be part of the customer management process.

In terms of what mechanisms may be used to keep processes across domains synchronized, the team should consider formal Method and Procedure documents with a formal change process, middleware based process modeling tools, and an enterprise canonical process model.

During this activity, the team should also decide on high-level rules for error and exception handling. These are typically documented in an ‘Error Handling Principles’ document that will accompany the Process Domain Model.

Inputs

Engagement plan, including context diagrams

Definition of scope or problem domain

Enterprise Process Management strategy/plan

Corporate Information Management strategy/plan

Existing and relevant system documentation

Corporate IT Architecture

Industry Standard process models (if appropriate)

The general process for developing activity area 520 is:

Operations

1. Identify and confirm the scope of the process domain modeling activities (i.e., whether the entire enterprise or a selected portion will be modeled). The planning horizon should also be confirmed in terms of either one or more initiatives or in terms of time (months or years).

2. Identify stakeholders such as “Cx”-level officers, area managers, SMEs and external entities.

3. In conjunction with Engagement Management and the client, develop a list of questions with which to probe for possible integration principles. For example, the following questions may be asked:

What are the integration goals and objectives?

Is it a goal to achieve flow-through processing (i.e., everything is entered only once)?

What is your eBusiness strategy, and do you have an implementation roadmap (prioritized list of initiatives)?

Where is the organization today on the Application Integration maturity model? Where do you want to be?

How long does it typically take to implement a systems project? How long should it take?

Is there an enterprise process owner; how will conflicts be resolved?

How should duplicate processes be resolved?

Are you currently using any workflow tools?

If so, which tools are you using or planning on using?

Do your systems track Awork in progress@ revenue?

Is establishing credit a manual or electronic process? If manual, do you track error rates for rekeying problems?

What is your order interval?

Do you track error rates for re-keying problems?

Is your sales-to-order entry process automated?

If so, which tools are you using or planning on using?

What type of orders do you process?

Do you know the length of the typical order interval, starting with the sale and ending with billing for the service?

Do you track the average cost-per-customer-order for this process?

Are you currently using eCommerce for the sales process?

Can your sales people enter new or additional orders via the Internet?

Can your existing customers add additional services via the Internet?

Do you provide electronic bill presentment and payment (EBPP) options?

Is there a canonical enterprise process model?

4. Conduct interviews and/or meetings with stakeholders to identify characteristics of the as-is and to-be states and to identify possible integration issues.

5. Develop graphical depiction of the as-in and to-be model and develop a draft of the integration principles.

6. Review and validate the model and principles with stakeholders. Iterate operations 4 and 5 as necessary to develop a sufficiently detailed and meaningful model.

7. Prepare for and participate in the cross-team review of all the models (see the Business Model Executive Review activity).

8. Prepare for and conduct a final review with senior management to obtain approval of the model.

9. Prepare the final documentation according to engagement or client standards.

The work products of activity 520 are the process domain model, process integration tenets and the error handling principles document, both of which are included in output 525.

Information domain model 530 is a graphical representation of the various Ainformation domains@ along with the associated knowledge management principles. Information domains are defined as the general categories of information that the organization views as strategic resources and wishes to manage at the enterprise level.

The purpose of activity 530 is to answer the following questions at the enterprise level:

What are the information domains?

Where does the information within the domains come from?

How is the information structured from a systems perspective so that the information domains can be managed?

Typical information domains include customers, suppliers, products or services, orders, inventory, human resources, and intellectual property, among others. Only information domains that require a specific IT strategy at the enterprise level need to be included.

In terms of information sources, the information team should consider both internal and external information sources. For example, the Customer information domain may include internal information sources such as customer relationships or hierarchies, financial track record, transaction history, correspondence log, current order status, channel utilization and many other possibilities. External information may include items such as credit status, market demographics or behavior patterns.

The information may be structured using one of several strategies:

Domain Object Model (DOM). When using this strategy, attributes of an object/event may be distributed across more than one application system. An object is created on demand when a related event occurs, rather than being stored. This strategy incorporates any level of canonical data or method abstraction.

Designated COTS. When using this strategy, one COTS application is the master/owner of the sub-entity; it is synchronized with other systems that use the same information. There is no data or method abstraction at this level, only a simple data synchronization.

Dedicated, custom-built application. All the information and business logic for a process is pulled into one application dedicated to that purpose. An example would be to build a separate product catalogue that would act as the central repository for the enterprise as well as for any adds, changes or deletes; any applications that required product data would receive information from this application.

Data Warehouse and Federated database. Data warehousing allows for a consolidated view of an entity, such as customer, from several systems. Federated databases provide the capability to move data directly from one database to another database, bypassing the application logic.

Manual synchronization. One or more systems are manually updated to be in synch with other systems.

The information structure should be decided early and recorded in the Information Domain Principles.

Inputs

Engagement plan, including context diagrams

Definition of scope or problem domain

Enterprise Knowledge Management strategy/plan

Corporate Information Management strategy/plan

Existing and relevant system documentation

Corporate IT Architecture or Enterprise Architecture

Operations

1. Identify and confirm the scope of the information domain modeling activities (i.e., whether the entire enterprise or a selected portion will be modeled). The planning horizon should also be confirmed in terms of either one or more initiatives or in terms of time (months or years).

2. Identify stakeholders such as “Cx”-level officers, area managers, SMEs and external entities.

3. In conjunction with Engagement Management and the client, develop a list of questions with which to probe for possible integration principles. The following is a starter list:

What internal and external information sources exist?

Is there a canonical enterprise data model?

Do you utilize decision support tools when selecting customer demographic types?

Is your product catalogue captured in a single system?

Which information domains or systems are the “master” in situations where the underlying systems have duplicate or inconsistent information?

Do you currently have a data warehouse or are you planning to implement one? If you have one, how effective is it?

Do you use multiple systems to provide similar functions? If so, which tools are you using or planning on using? What mechanisms are in place to keep them synchronized?

4. Conduct interviews and/or meetings with stakeholders to identify characteristics of the as-is and to-be states and to identify possible integration issues.

5. Develop graphical depiction of the as-in and to-be models and develop a draft of the integration principles.

6. Review and validate the model and principles with stakeholders. Iterate operations 4 and 5 as necessary to develop a sufficiently detailed and meaningful model.

7. Prepare for and participate in the cross-team review of all the models (see the Business Model Executive Review activity).

8. Prepare for and conduct a final review with senior management to obtain approval of the model.

9. Prepare the final documentation according to engagement or client standards.

Work Products of activity 530 include an Enterprise Information Domain Model 535 and Enterprise Information Domain Principles. Enterprise Information Domain Model 535 should be very brief showing the as-is state (if appropriate), the to-be state (or both states could be combined by using shading or other notation techniques to differentiate the two states).

The Enterprise Information Domain Principles should include the top integration principles related to knowledge management. The principles should be high-level, which generally means there should be no more than 5 or 6 at the most.

Enterprise systems interface model 540 is the highest-level model of the application systems in the enterprise and the hardware, software and network infrastructure that links them together.

The units represented in model 540 are a high-level aggregation of systems and the interface architecture that links them. If there are more than 20 to 30 systems, then related systems should be categorized in groups and combined. Both internal and external links should be modeled.

Model 540 should show the major data flows as simple connections between systems. At this level, model 540 should be focused on the main business process data flows, omitting data flows associated with maintenance functions.

The purpose of activity 540 is to answer the following questions at the enterprise level:

What are the categories of application systems that are strategic and should be managed at the enterprise level?

What internal and external systems are included in each of the categories?

What is the structure (architecture) of the major links between the systems?

The model should indicate whether the systems are connected through point-to-point interfaces, bus or hub architecture, network architecture, or external links to clients or trading partners. It could also show where information exchange takes places through manual processes, such as magnetic tape transfer by courier, fax, manual re-keying, or any other type of manual process.

Model 540 should be highly graphical and make use of different colors or shapes of lines and various icons to represent different types of interfaces.

Inputs

Engagement plan, including context diagrams

Definition of scope or problem domain

Enterprise Process Management strategy/plan

Corporate Information Management strategy/plan

Existing and relevant system documentation

Corporate IT Architecture or Enterprise Architecture

Operations

1. Identify and confirm the scope of the systems interface modeling activities (i.e., whether the entire enterprise or a selected portion will be modeled). The planning horizon should also be confirmed in terms of either one or more initiatives or in terms of time (months or years).

2. Identify stakeholders such as “Cx”-level officers, area managers, SMEs and external entities.

3. In conjunction with Engagement Management and the client, develop a list of questions with which to probe for possible integration principles. The following is a starter list:

Where is the organization today on the Application Integration maturity model? Where do you want to be?

How long does it typically take to implement a systems project? How long should it take?

What is the enterprise security policy regarding the infrastructure (such as authorization, confidentiality, privacy, and non-repudiation)?

What is the trusted domain in which a single login is required?

What are your interface standards and do they support API's, stored procedures, screen scraping or a combination?

What level of application insulation is required? For example, are your middleware interfaces (e.g., ‘adapters’) intrusive/non-intrusive, dynamic/static, or thick/thin?

Do you have a separate integration test environment?

Are you using any Interconnection Gateways?

Have the application system owners and interface owners been identified?

Have you explored using middleware tools to integrate your various software tools? If so, which packages are you using or planning on using?

Have you explored using a service bureau as an interim step to implementing your systems?

Does an enterprise architecture document exist?

4. Conduct interviews and/or meetings with stakeholders to identify characteristics of the as-is and to-be states and to identify possible integration issues.

5. Develop graphical depiction of the as-in and to-be model and develop a draft of the integration principles.

6. Review and validate the model and principles with stakeholders. Iterate operations 4 and 5 as necessary to develop a sufficiently detailed and meaningful model.

7. Prepare for and participate in the cross-team review of all the models (see the Business Model Executive Review activity).

8. Prepare for and conduct a final review with senior management to obtain approval of the model.

9. Prepare the final documentation according to engagement or client standards.

The Work Products of activity 540 include Enterprise Systems Interface Model 545 and Enterprise Systems Interface Principles. Both the as-is and to-be states should be modeled. The as-is model should include any client future systems plans.

The model should be very brief. It should contain one page each for as-is and to-be states (or one page that shows both using shading or other techniques).

The Enterprise Systems Interface Principles should include the top integration principles related to system interfaces. The principles should be high-level, which generally means there should be no more than 5 or 6 at the most for interfaces.

Enterprise operations model 550 shows the organization's key operations domains at the conceptual level and key service areas within the domains.

The purpose of activity 550 is to answer the following questions at the enterprise level:

What are the high-level operations domains that are managed at the enterprise level?

What key internal or external services are provided by each of the operations domains?

Which organizational group or individual is responsible for each of the operations domains and to whom are they providing the services?

What mechanisms and key tools are used to provide the services?

During activity 550, the team may also define, at a high level, the service levels for the integrated environment. While the detailed metrics and thresholds may not be finalized until the logical or physical activity areas, it is important to understand at the business level which service level areas are the key ones to be used to measure the operational readiness of the to-be integrated environment. These should be documented in an ‘Operations Readiness’ document that will accompany the Operations Model.

Inputs

Engagement plan, including context diagrams

Definition of scope or problem domain

Policies and Procedures relevant to operations

Corporate Information Management strategy/plan

Existing and relevant system documentation

Corporate IT Architecture or Enterprise Architecture

Operations

1. Identify/confirm the scope of the operations modeling activities (i.e., entire enterprise or a selected portion). The planning horizon should also be confirmed in terms of either one or more initiatives or in terms of time (months or years).

2. Identify stakeholders such as “Cx”-level officers, area managers, SMEs and external entities.

3. In conjunction with Engagement Management and the client, develop a list of questions with which to probe for possible integration principles. The following is a starter list:

What service level measures and metrics are currently in place?

What are your expectations of the integrated environment in terms of performance, reliability, availability, maintainability and throughput?

What are your internal and external security and audit controls?

What are your business volume projections in each of the operational areas?

What opportunities exist for productivity improvements?

What are the operations goals and objectives relative to the integration effort?

Where is the organization today on the Application Integration maturity model? Where do you want to be?

How long does it typically take to implement a systems project? How long should it take?

4. Conduct interviews and/or meetings with stakeholders to identify characteristics of the as-is and to-be states and to identify possible operations issues.

5. Develop graphical depiction of the as-in and to-be model and develop a draft of the operations principles.

6. Review and validate the model and principles with stakeholders. Iterate operations 4 and 5 as necessary to develop a sufficiently detailed and meaningful model.

7. Prepare for and participate in the cross-team review of all the models (see the Business Model Executive Review activity).

8. Prepare for and conduct a final review with senior management to obtain approval of the model.

9. Prepare the final documentation according to engagement or client standards.

The Work Products of activity 550 include Enterprise Operations Model 553, Enterprise Operations Principles, and an Operations Readiness Document. Regarding model 553, both the as-is and to-be states should be modeled. The as-is model should include any client future systems plans.

The model should be very brief. It should contain one page each for as-is and to-be states (or one page that shows both using shading or other techniques).

Regarding the Enterprise Operations Principles, the operations principles should be high-level; which generally means there should be no more than 5 or 6 at the most for the operations model.

The Operations Readiness Document should describe (at a business level) which key service level areas will be used to measure the operational readiness of the to-be integrated environment.

During business model executive review activity 555, which closes Enterprise Business Model activity area 450, the business models are reviewed at the executive level. The purpose of this walk through is to ensure understanding and buy-in of the current and future states of the organization's systems.

Inputs

Enterprise Information Domain Model

Enterprise Process Domain Model

Enterprise Systems Interface Model

Enterprise Operations Model

Operations

1. Conduct meeting with all appropriate executives of the client organization, along with the top managers of the AMS team. Present and walk through each business model.

2. Confirm understanding, approval on the part of the client executives.

3. Publish approved version of the models.

Work Product(s)

Approved Enterprise Business Specification Document. Organizational Norms Document (summary of findings of consensus areas that can be used for assimilating team members).

Enterprise logical model activity area 460. As part of activity area 460, various aspects of the organization's systems are modeled from a logical point of view. These models show what the interactions between systems are, in terms of information, processes, interfaces, and operations. These conceptual relationships do not necessarily correspond to how the systems are physically implemented.

The logical models may be fairly detailed. However, they should be general enough to be understood at the management level.

Ideally, the logical model should be developed for both the current (as-is) state and the desired (to-be) state. However, it is not always necessary to create an as-is model. This is a judgement call that the team lead should make in conjunction with the Engagement Manager and the client.

A Cross-Team Logical Model Review is held at the end of activity area 460.

Logical process event model activity 560 produces an integrated view of business processes throughout the problem domain (all the applications to be integrated). Only the interaction events between applications are modeled; the detailed process operations that occur within each application are usually omitted from the enterprise level model. Logical process event model activity 560 breaks down these general business processes into event flows and shows which system is responsible for which function.

Logical process event model activity 560 includes several operations and work products:

Business Scenarios. Each business scenario describes a series of events depicting a business process. Each scenario is a script that describes how to perform a process and the system's role in the process.

Logical Process Diagrams. This type of diagram is a graphical representation of a business process. There will most likely be more than one of these models. There may, for example, be one for each business scenario.

Systems Interaction Matrix. These matrices map each step in the business scenario to the appropriate system; there is one for each business scenario. The event(s) associated with each step are noted in the matrix.

A Function-System Matrix, which maps the major functions to the responsible system(s) and/or manual process. The matrix need only include the functions that involve more than one system in the problem domain. This matrix serves as a summary of the information in the Systems Interaction Matrices.

Logical event flow diagrams, which indicate how events are logically passed between applications and the information broker, and in what sequence. At a logical level, these diagrams hide the details of how event iterations will actually be implemented (e.g., event splitting and complex event routing that will be done through middleware components).

An Error Handling Approach, documented in greater detail than in the Error Handling Principles document. The approach should include information on such topics as error detection responsibilities, error reporting and logging procedures, and the information contained in error messages. Error handling should also be included as one of the processes modeled in the logical event flow diagrams.

During activity 560, the Process team may also produce an Impact Analysis document that may be used to communicate impacts to teams outside the EAI effort.

Inputs

Enterprise Process Domain Model

Error Handling Principles document

Application Specifications

Operations

1. Identify stakeholders, such as area managers and SMEs. These are the people that are needed to support the construction of the Logical Process Event Model and to approve the completed model.

2. Collect any existing Logical Process Event Models or related documentation.

3. Collect the specifications for any applications being built or modified in concurrence with the EAI effort.

4. Conduct interviews and/or meetings with the stakeholders to develop and document business scenarios. Scenarios should be developed for those processes that involve integration (i.e., cross more than one system).

5. Develop Logical Process Diagrams to illustrate the business scenarios.

6. For each business scenario, map the functions in each step to the responsible system. Document these operations in a Systems Interaction Matrix (one for each business scenario). Assign event names to each step that involves crossing systems.

7. Summarize the information in the System Interaction Matrices in the Functional-System Matrix, mapping logical functions to the responsible system. For each function, there may be a primary and secondary system.

8. Conduct interviews and/or meetings with the stakeholders to develop the list of logical events. For each event, develop a logical event flow diagram that shows the end-to-end applications sequence.

9. Conduct interviews and/or meetings with the stakeholders to document the current error handling approach, and to develop the new approach. Document this approach in the Error Handling Approach document.

10. Review and validate document with stakeholder managers and SMEs. Repeat operations 4, 5 and 6 as necessary to develop an accurate and sufficiently detailed model.

11. Prepare for the cross-team review of all the models (see the Cross-Team Logical Model Walkthrough activity) by preparing an Impact Analysis Summary, which documents the impact of Process thread activities on groups outside the EAI project.

12. After the cross-team review, prepare for and conduct a final review with managers to obtain approval of the model.

13. Prepare and publish the final documentation according to engagement or client standards.

The Work Product of activity 560 is logical process event model 563, which includes:

Business Scenarios

Logical Process Diagrams

Systems Interaction Matrices

Functional System Matrix

Logical Event Flow Diagrams

Error Handling Approach

Impact Analysis Summary for Process Thread

Enterprise logical information model activity 570 produces an integrated view of business data throughout the problem domain.

On an EAI project, logical information modeling activity 570 focuses on the data that is “visible” from an external perspective, that is, the data that is exchanged between applications and is thus relevant to integration.

Which specific work products are produced depends on the information management strategy being used; this strategy should have been chosen when developing the Enterprise Information Domain Principles.

Logical information model activity 570 includes several operations and work products:

Logical Data Model. This model shows the information entities and their relationships. This diagram models only the information that is relevant to integration. If a domain object model approach is being used, these entities will be considered canonical entities.

Data Mapping Chart. The purpose of this chart is to show the relationship of entities from one integrated system to another, as well as to canonical entities. When appropriate, the mappings should be brought down to the attribute level. As with other logical information-related work products, data mappings always deal with data involved in integration with other systems, not just all data within a particular application being integrated.

Entity Definitions. These definitions should be produced if the knowledge/information management strategy involves a domain object model. These are canonical data entities; they define how the data will be understood and represented by the middleware. Thus messages sent to the middleware from any application must be converted to adhere to this definition. These canonical entities are defined at the attribute level. Characteristics of each attribute, including the source application, are recorded in the Entity Definition template.

Logical Event Definitions. These definitions define what data is exchanged between the entities in a logical event flow. (Logical Event Flow Diagrams are being developed concurrently as part of the Logical Process Model activity.) At the logical level, event definitions should focus on how data is mapped and/or transformed between two entities; it should hide the specific operations that may need to take place as part of that transformation, i.e., those operations involving middleware components. The logical event definitions should include:

A specification of the event fields, down to the data type level

A specification of the data mappings between the applications using the event (for example, the field in an order management system that corresponds to a field in a billing system)

A specification of any transformations that are required to exchange data between applications (for example, reformatting of customer address information).

In building the logical models, the Information team should use data dictionaries or other existing information to understand various characteristics of the data, including integrity issues and data latency requirements.

Both the as-is and to-be states should be modeled.

During activity 570, the Information team should also produce an Impact Analysis document that will be used to communicate impacts to teams outside the EAI effort.

Inputs

Enterprise Information Domain Model

Enterprise Process Domain Model

Application Specifications (from application development teams)

Enterprise Logical Process Event Model

Operations

1. Identify stakeholders, such as area managers and SMEs. These are the people that are needed to support the Logical Information Model tasks and to approve the completed products.

2. Collect any existing Logical Information Models or related documentation.

3. Collect the specifications for any applications being built or modified in concurrence with the EAI effort.

4. Conduct interviews and/or meetings with the stakeholders to identify the major entities and their relationships for both the as-is and to-be states. Only those entities that involve more than one system should be included.

5. If using a knowledge management approach that requires data mapping: conduct interviews, meetings, and/or working sessions with the stakeholders to map data from one application to another. Only those attributes relevant to integration should be included.

6. If using a domain object model approach: conduct interviews and/or meetings with managers and SMEs to develop the canonical entity definitions.

Determine the attributes associated with each entity, and determine the source database for each.

If the attribute is found in multiple databases, determine which database is the system of record.

7. Conduct interviews and/or meetings with the stakeholders and with the Process team to develop logical event definitions. A logical event definition should be developed for each step in each logical process event flow. This process may include the following tasks:

Learn what the operations are in each logical event flow.

Determine what data (at the attribute level) is required by the application that is receiving the event in each step.

Determine, for each attribute, where that data comes from (e.g., requires user input; requires external system input; can be derived, and so on).

In the Logical Event Definition template, record the mapping of the original data from the sending application to the receiving application.

8. Review and validate document with stakeholder managers and SMEs. Repeat operations 4 and 5 as necessary to develop an accurate and sufficiently detailed model.

9. Prepare for the cross-team review of all the models (see the Cross-Team Logical Model Walkthrough activity) by preparing an Impact Analysis Summary, which documents the impact of Information thread activities on groups outside the EAI project.

10. After the cross-team review, prepare for and conduct a final review with managers to obtain approval of the model.

11. Prepare and publish the final documentation according to engagement or client standards.

The Work Products of activity 570 include Logical Information Model 575,

Data Mapping Chart

Entity Definition

Logical Event Definition

Impact Analysis Summary for Information Thread

Logical systems interface model activity 580 is an integrated view of the connections between any applications included in the problem domain. Activity 580 breaks the problem domain into logical subsystems and shows more detail about each interface.

Logical systems infrastructure model 580 may include the following:

Application software specifics (including version number)

Databases associated with each application (if applicable)

An indication of the direction of information flow between applications and the middleware (and/or other applications)

An indication of whether the interaction is synchronous or asynchronous

An indication of the interaction paradigm (e.g., conversational, request/reply, publish/subscribe, polling, batch message/data passing, or message queuing)

As with the other models, both the as-is and to-be states should be modeled.

During activity 580, the Interfaces team may also produce an Impact Analysis document that will be used to communicate impacts to teams outside the EAI effort.

Inputs

Enterprise Systems Interface Model

Enterprise Process Domain Model

Application Specifications

Enterprise Logical Process Event Model

Operations

1. Identify stakeholders, such as area managers and SMEs. These are the people that are needed to support the construction of the Logical Systems Interface Model and to approve the completed model.

2. Collect any existing System Interface Models or related documentation.

3. Collect the specifications for any applications being built or modified in concurrence with the EAI effort.

4. Conduct interviews and/or meetings with managers and SMEs to gather information about the current interfaces and to plan the new interfaces. Members of the Process team may be involved in these meetings, in order to provide information about the flow of events between applications. The following are among the topics that should be covered:

Specific software and databases used for each application (including version)

Direction of information flow between applications (and middleware, if applicable)

Required timing of information flow (synchronous vs. asynchronous) and type of interaction (such as request/reply or publish/subscribe)

5. Using the information just gathered, develop a graphical representation of the as-is and to-be systems interface models.

6. Review and validate document with stakeholder managers and SMEs. Iterate operations 4 and 5 as necessary to develop an accurate and sufficiently detailed model.

7. Prepare for the cross-team review of all the models (see the Cross-Team Logical Model Walkthrough activity) by preparing an Impact Analysis Summary, which documents the impact of Interfaces thread activities on groups outside the EAI project.

8. After the cross-team review, prepare for and conduct a final review with managers to obtain approval of the model.

9. Prepare and publish the final documentation according to engagement or client standards.

The Work Products of activity 580 include Enterprise Logical Systems Interface Model 585, which consists of a graphical representation of the as-is and to-be interfaces, and an Impact Analysis Summary for the Interfaces Thread.

Operations architecture activity 590 is part of the operations thread, during which the Operations team focuses on the operational aspects of the anticipated integration infrastructure.

As part of activity 590, the Operations team produces the following:

A Hardware and Network Configuration Diagram that provides a pictorial representation of the hardware and network configuration that is required to support the various applications and databases, etc. One diagram should be produced for the as-is state. Another should be produced that shows the anticipated to-be state. (At this point, it is too early to know all the hardware and network specifications; these are documented to the extent possible at this time, then refined as part of the next activity area.) This model will be at a very high-level and will convey information such as the following:

Each machine, identified by its type, such as Sun 4500, and name (the identifier assigned by client)

Physical location of machines or groups of machines,such as a city or building

Connections between machines, portrayed as simple links (without details)

Software versions and databases on each machine

A document that describes the required service levels of various operational services, for both as-is and to-be states. These include specific values in the following areas:

Administration (ability to discover and configure infrastructure, and monitor data transformation, workflow and routing)

Availability and performance (message warehousing, performance monitoring, performance metrics, gathering sizing information, plotting trends for capacity planning, maintaining availability log)

Integration infrastructure operations (setting event thresholds and alarm notifications, common services, integration with management application)

Reliability

Security

A Configuration Management Plan, which should include topics such as the following:

Version control procedures

Export/import hierarchical order

File check-out/check-in procedures

File migration procedures

File backup procedures

Event creation and migration; maintenance of event inventory

During this activity, the Operations team should also produce an Impact Analysis document that will be used to communicate impacts to teams outside the EAI effort.

Inputs

All Enterprise Business Models

Application Specifications

Enterprise Architecture

Operations

1. Identify stakeholders, such as area managers and SMEs. These are the people that are needed to support the construction of the Operations Architecture and to approve the completed model.

2. Collect any existing Operations Architectures or related documentation.

3. Collect the specifications for any applications being built or modified in concurrence with the EAI effort.

4. Conduct interviews and/or meetings with Operations staff, along with other managers and SMEs as necessary, to determine the machines that are currently being used, which machines are connected to each other, where the machines are located, and what software and databases reside on each.

5. Get input from the software vendors to determine what machines that are needed to support the new integration infrastructure. Find out what their software requires in terms of operating system, capacity, etc., and what hardware they recommend. Check their recommendations against past AMS experience with the same software products.

6. Determine which machines will be connected to each other, where the machines will be located, and what software and databases will reside on each.

7. Develop a high-level graphical representation (the Hardware and Network Configuration Model) that conveys both the as-is and to-be information.

8. Conduct interviews and/or meetings with Operations staff, along with other managers and SMEs as necessary, to review the list of service level categories (both as-is and to-be) that were developed as part of the Operations Model.

9. Develop a list of the different ways each category is currently measured, and a list of how they will be measured after integration. For example, the service level for the category Performance might be measured by end user response time or batch processing time. Try to limit the number of categories and measures. The total number of measures should not exceed 15 or 20.

10. Conduct interviews and/or meetings with Operations staff, along with other managers and SMEs as necessary, to document the current targets for the various service levels, and to agree on what the targets for the new integrated system will be.

11. Have an expert in each service level category give the initially proposed service level targets a “reasonableness test”. If is seems as though it would be difficult, expensive or just not possible to meet the service level target, the team should do an more in-depth analysis of the costs and trade-offs involved. They should document their decisions made, following the guidelines described in the Best Practices paper “Writing Decision Papers” (Hess, 1994).

12. Review and validate document with stakeholders (Operations staff, managers, and SMEs). Iterate/repeat operations 4 through 11 as necessary to develop an accurate and sufficiently detailed work product.

13. Prepare for the cross-team review of all the models (see the Cross-Team Logical Model Walkthrough activity) by preparing an Impact Analysis Summary, which documents the impact of Operations thread activities on groups outside the EAI project.

14. After the cross-team review, prepare for and conduct a final review with managers to obtain approval of the model.

15. Prepare and publish the final documentation according to engagement or client standards.

16. Develop a Configuration Management Plan. This can most likely be developed using examples from past projects.

The Work Products of activity 590 is operations architecture management document 593, which includes

Hardware and Network Configuration Diagram

Required Service Level Values

Configuration Management Plan

Impact Analysis Summary for Operations Thread

During cross-team model walkthrough activity 595, which closes Enterprise Logical Model activity area 460, the Information, Process, Interfaces, and Operations teams meet for a detailed walkthrough of the logical models that were produced as part of this activity area.

The walkthrough should also be attended by those organization members who are outside the EAI project but are directly impacted by it. This includes stakeholders in the organization's application development teams and business units.

In addition, it may also be useful for the Integration Test Team to attend this walkthrough, to allow for early knowledge transfer.

The purpose of this walkthrough is to ensure consistency and understanding between teams, and to spot any issues early.

Inputs

Enterprise Logical Information Model

Enterprise Logical Process Event Model

Enterprise Logical Systems Interfaces Model

Operations Architecture

Impact Analysis Summaries from Information, Process, Interfaces, and Operations Teams

Operations

1. Conduct a walkthrough meeting with representatives from the Information, Process, Interfaces, and Operations teams; applications and business unit stakeholders; and the Integration Test team. Present and walk through each logical model, as well as the Impact Analysis Summaries from each team.

2. Record any issues that arise.

3. Update the various models as issues are resolved.

4. Publish the approved version of the models.

Work Product(s)

Approved Enterprise Logical Models

As part of Enterprise physical model activity area 470, various dimensions of the organization's systems are modeled from a physical point of view. These models show how the systems physically interact in terms of information, processes, and interfaces.

Physical models 600, 610, and 620 show how the logical model will be physically implemented; thus they are typically longer and more detailed than logical models 560, 570, and 580. For example, there will likely be more than one physical event per logical event, because the physical event implementation may be different from the logical event.

Physical models 600, 610, and 620 will be used mainly by IT staff members or others directly involved in the project effort. These staff members will review the models during the Cross-Team Physical Model Review, held at the end of the activity area.

Enterprise test strategy 640 is also developed as part of this activity area. This Strategy gives a high-level description of the testing activities that will take place during the EAI project.

Physical process event model 600, part of the Process thread, shows the actual physical implementation of logical process event model 560. Physical process event model 600 consists of:

Physical event flow diagrams, which provide a drill-down of the logical event flows that were developed as part of the previous activity area. For each logical event flow, there is one or more physical events flows. The physical event flow diagram deals with how the event flow will actually be implemented, at a low level of granularity, and shows the following:

In addition to showing applications involved at each operation, also includes the flows between the information broker and specific middleware components

Event splitting and routing (in series or in parallel) that may be necessary to communicate with more than one application

Event chaining (in series), which is necessary when more than one event is necessary to retrieve all the information required from an application (i.e., more than one physical event is necessary to achieve a single logical event)

An Error Handling Details document that includes the same topics covered in the Error Handling Approach paper (error detection responsibilities, error reporting and logging procedures, error message information), but with more details about implementation. It may also include information regarding error message format, developer responsibilities, error severity levels, recovery procedures, and auditing procedures. Error handling should also be included as one of the processes documented in the physical event flow diagrams.

As with the other models, both the as-is and to-be states should be modeled. During this activity, the Process team may also produce an Impact Analysis document that will be used to communicate impacts to teams outside the EAI effort.

Inputs

Enterprise Logical Process Event Model work products

Operations

1. Collect any existing Physical Process Models or related information.

2. Conduct interviews and/or meetings with managers and SMEs to develop physical event flow diagrams for each physical event, for both the as-is and the to-be states. The diagrams should show end-to-end applications sequence and if applicable, include middleware components.

3. Conduct interviews and/or meetings with the stakeholders to document the current error handling details, and to develop the new details. Document this approach in the Error Handling Details document.

4. Review and validate both documents with managers and SMEs. Repeat operations 2 and 3 as necessary to develop an accurate and complete set of physical event flows and error processing details.

5. Prepare for the cross-team review of all the models (see the Cross-Team Physical Model Walkthrough activity) by preparing an Impact Analysis Summary, which documents the impact of Process thread activities on groups outside the EAI project. This summary can be an update of the summary produced as part of the Enterprise Logical Model activity area.

6. After the cross-team review, prepare for and conduct a final review with managers to obtain approval of the model.

7. Prepare and publish the final documentation according to engagement or client standards.

The Work Products of activity 600 is an enterprise physical process evant model 605, which includes:

Physical Event Flow Diagrams and

Error Handling Details

During physical information model activity 610, which is part of the Information thread, the Information team produces the following:

The Enterprise Physical Information Model, which shows the actual physical implementation of the Logical Information Model.

An assessment of the quality of the existing enterprise production data, and proposed solutions for any problems that are uncovered.

The Physical Information Model consists of physical event definitions, which define what information is exchanged between the applications involved in a physical event flow. (Physical event flow diagrams are being developed concurrently as part of the Physical Process Model activity.) The physical event definitions provide the information required to construct the actual events.

Physical event definitions include the same data mapping specifications as logical event definitions. However, they may include extra fields (such as a database partition ID) that are necessary at the physical level, but not at the logical level. There may also be more than one physical event definition per logical event definition.

Inputs

Enterprise Logical Information Model work products

Enterprise Physical Process Model work products

Enterprise Physical Interface Model

Existing Enterprise Physical Information Models

Sample production data extracts

Operations

1. Collect any existing Physical Information Models or related information.

2. Conduct interviews and/or meetings with stakeholder managers and SMEs to develop the physical event definitions. Members of the Process team should participate in some of these meetings, in order to communicate the operations in the physical process event flows.

Begin with the logical event definitions, add the elements that are necessary for the physical implementation of event. For these additional fields, follow the same process that was used to build the logical event definitions.

Using the physical event process flow diagrams (from the Process team) as a starting point, determine where more than one event is needed to implement a logical event. Develop definitions for these events.

3. Review and validate definitions with stakeholder managers and SMEs. Repeat step 3 as necessary to develop and accurate and complete set of physical event definitions.

4. Obtain sample extracts of production data from each system to be integrated.

5. Analyze the samples to determine the extent to which actual data matches the expected data model.

6. Prepare a report that shows deviations from expected model and proposed methods of resolving invalid data. Resolutions should be implemented as part of the Infrastructure Design and Infrastructure Assembly activity areas. Examples of these resolutions would include:

Cleaning the data in the source system

Building filters in the new integration interfaces that ignore invalid data

Building translators in the middleware or interfaces that convert the invalid data

Review and validate the data analysis document with stakeholder managers and SMEs. Update proposed solutions based on input from stakeholders.

7. Prepare for the cross-team review of all the models (see the Cross-Team Physical Model Walkthrough activity) by preparing an Impact Analysis Summary, which documents the impact of Information thread activities on groups outside the EAI project. This summary can be an update of the summary produced as part of the Enterprise Logical Model activity area.

8. After the cross-team review, prepare for and conduct a final review with managers to obtain approval of the model.

9. Prepare and publish the final documentation according to engagement or client standards.

The Work Product of activity 610 is physical information model 615, which includes Physical Event Definitions and Data Quality Assessment and Solutions.

Physical Interface model activity 620, which is part of the Interfaces thread, details the entire the physical implementation of the enterprise logical systems interface model to be constructed.

The Physical Interface model corresponds to the middleware components displayed in the Physical Event Flow Diagrams (part of the Physical Process Model).

The Physical interface model should contain the same details found in the aforementioned Logical Systems Interface Model, with the addition of the following:

Should show connections or transformations though middleware interfaces and/or transformers (e.g., ‘adapters’, ‘connectors’, or ‘agents’).

Should indicate whether those middleware components involve existing or customized software.

Indication of the specific part of an application (the user interface, the API, or database) that connects with the middleware and/or other applications.

Indication of the hardware on which each software component or database sits and the physical location of the machine.

An indication of the frequency and volume of information being passed between systems.

As with the other models, both the as-is and to-be states should be modeled.

Inputs

Enterprise Logical Systems Interface Model

Physical Process Event Flow Diagrams

Physical Event Definitions

Operations

1. Collect any existing Physical Systems Interface Models or related information.

2. Conduct interviews and/or meetings with managers and SMEs to develop the Physical Systems Interface Model for both the as-is and to-be states. Start with the ‘as-is’ Logical Systems Interface Model, and expand it by adding details in the following areas:

If there are middleware components in the as-is architecture: For each connection between an application and the middleware, specify the specific middleware components (e.g., ‘adapters’, ‘agents’) that information flows through. This information should be found in the physical event flows Wart of the Physical Process Model).

Show the different parts of each application (GUI, API, and/or database, as applicable). The model should indicate connections between a specific part and other applications (or the middleware).

For each software component, add the associated hardware type and the location of the machine.

Indicate the current frequency and volume of information being passed

3. Review and validate the document with managers and SMEs. Repeat step 2 as necessary to develop an accurate and complete model.

4. Prepare for the cross-team review of all the models (see the Cross-Team Physical Model Walkthrough activity) by preparing an Impact Analysis Summary, which documents the impact of Interfaces thread activities on groups outside the EAI project. This summary may be an update on the summary developed as part of the Logical Model activity area.

5. After the cross-team review, prepare for and conduct a final review with managers to obtain approval of the model.

6. Prepare and publish the final documentation according to engagement or client standards.

The Work Product of activity 620 is Physical Interface Model 625.

During operations management model activity 630, which is part of the Operations thread, the Operations team builds on the work produced during the Operations Architecture activity 590. As part of activity 630, the Operations team does the following:

Further refines and develops the Anticipated Hardware and Network Configuration diagram, updating as necessary based on decisions made since the diagram was first produced. The team also adds greater detail about physical implementation. The following types of information may be added to the diagram (and/or accompanying text):

Specific components used in network configuration

Capacity of networks and computers

Security policies

Specific environments

Configuration management and migration procedures

This physical implementation is meant to achieve the service levels determined previously. There should be diagrams produced for both the as-is and to-be states.

Determines how the required service levels of various operational services are to be measured. The team will document what tools will be used, how often the measures will be gathered, and who is responsible.

Develops a Production Readiness checklist that identifies items that must be evaluated and activities that must be performed in order to enable a successful production rollout of the integration infrastructure. The checklist should be used to track, for each item, the due date, the level of readiness, the owner of the item, and any other comments or references. The checklist will likely include items in the following areas:

Hardware/software/network infrastructure

Interfacing systems

Service level agreements

User documentation and training

Operations

User support (help desk)

Problem resolution

Configuration management

Application management

Capacity planning and management

Inputs

Operations Architecture document

Operations

1. Work with Operations staff to record additional details about existing operations, and to develop the details about the to-be operations. It may also be useful to get the recommendations of hardware and software vendors. Information collected should include:

Specific components used in network configuration

Capacity of networks and computers

Security policies

Specific environments

Configuration management and migration procedures

2. Conduct interviews and/or meetings with Operations managers and SMEs to document how existing service levels are currently measured (i.e., specific tools and techniques), when they are measure, and what team or role is responsible. Develop the to-be procedures, building on the as-is procedures if possible.

3. Conduct interviews and/or meetings with Operations managers and SMEs to develop a Production Readiness Checklist, including due dates and owners.

4. Review and validate documents with managers and SMEs. Repeat operations 1, 2 and 3 as necessary to develop an accurate and complete model.

5. Prepare for the cross-team review of all the models (see the Cross-Team Physical Model Walkthrough activity) by preparing an Impact Analysis Summary, which documents the impact of Operations thread activities on groups outside the EAI project.

6. After the cross-team review, prepare for and conduct a final review with managers to obtain approval of the model.

7. Prepare and publish the final documentation according to engagement or client standards.

The Work Product of activity 630 is operations management model 635, which includes:

Detailed Hardware and Network Configuration diagram

Service Level Measurement Tools and Procedures

Production Readiness Checklist

Test strategy activity 640 provides an overview of the scope and procedures for the various levels of integration testing. While prepared by the Integration Testing Team, test strategy activity 640 produces an Enterprise Test Strategy which includes information about other levels of test (unit and string testing, performance test, and production readiness test). Test strategy activity 640 thus requires the input of other teams that are responsible for those levels of test.

The Enterprise Test Strategy contains high-level descriptions of:

The recommended levels of testing to be conducted for the EAI project, and the scope of each.

The test methodology, including the three main phases of testing (planning; preparation; and execution, verification, and correction).

If known, an overview of new or changed business processes that will be validated as part of integration test.

The procedures for baseline test data management Regression test productivity tools (if regression test is to be performed)

The procedures for tracking and reporting; includes incident tracking procedures and test case management procedures

The test documentation that will be produced in each level of test. This documentation will likely consist of the following:

Test Scenario. A collection of scripts that test a specific function or grouping of functions

Test Script. A set of procedures, organized in the exact sequence in which they are performed. A test script includes information such as setup parameters, input files, instructions for performing online functions or for executing batch jobs, and verification procedures. The execution of the script allows for the verification of a collection of associated test cases.

Test Case. A concise set of test conditions, data conditions, expected results (that identify database updates and file outputs), and verification procedures. There are one or more test cases in each script.

The Enterprise Test Strategy should be shared with the application development teams in a formal handoff meeting. These teams are considered separate from the EAI project; however, the applications are going to be used to perform the Integration Test and perhaps other levels of testing. It is helpful for the application teams to know what the expectations and needs of the EAI teams are in terms of testing.

During activity 640, the Integration Test team should also plan for the training of testers in the functionality of the applications being integrated, as well as in the functionality of the middleware and its components.

Inputs

Information on unit and string testing from the development teams

Information on performance testing, production readiness testing from Operations team

Information on new or changed business processes from the Organizational Development/Change Management (OD/CM) team

Existing organizational standards, tools for testing

Operations

1. Conduct meetings with relevant managers and SMEs to decide what levels of test are necessary and agree on the general scope of those test levels. These may include:

Unit test

String test

Integration test

Regression test (if applicable)

Performance test

Production readiness test

2. Decide what documentation will be produced for each type of testing. The type of deliverable and level of detail will vary based on the level of test. To make these decisions, the Integration Test team works with other teams: with the Information, Process, and Interfaces teams for unit and string testing; and with Operations teams for performance and production readiness tests.

3. If applicable, consult with OD/CM team to find out about any business processes that have been added or changed as a result of, or in concurrence with, integration.

4. The Integration Test team determines high-level procedures in various areas:

Baseline test data management

Regression test productivity tools (if regression test is to be performed)

Configuration management

Tracking and reporting (incident tracking and test case management)

5. Document this information in the Enterprise Test Strategy template.

6. Review and validate the document with the relevant managers and SMEs. Repeat the above operations as necessary to develop a complete and accurate Test Strategy.

7. Conduct a review and handoff meeting with managers and testing SMEs from the applications team. Walk through the Enterprise Test Strategy and confirm understanding on the part of the applications teams. Emphasize the schedule of testing and the dependencies on the applications teams.

8. Conduct additional handoff meetings as necessary with other teams that will be required to execute or support the different levels of testing. These teams include the Interfaces team (performance test) and Operations team (production readiness test). Walk through the Enterprise Test Strategy, emphasizing the role of each team, the testing schedule, and testing dependencies.

9. Prepare and publish the final documentation according to engagement or client standards.

The Work Product of activity 640 is Enterprise Test Strategy 643.

During cross-team model walkthrough 645 activity, which closes Enterprise Physical Model activity area 470, the Information, Process, Interfaces, and Operations teams meet for a detailed walkthrough of the physical models that were produced as part of this activity area.

In addition, it may also be useful for the Integration Test Team to attend this walkthrough, to allow for knowledge transfer.

The purpose of walkthrough 645 is to ensure consistency and understanding between teams, and to spot any issues before the design activities begin.

In addition, it may also be useful for the Integration Test Team to attend walkthrough 645, to allow for early knowledge transfer.

Inputs

Enterprise Physical Information Model

Enterprise Physical Process Event Model

Enterprise Physical Systems Infrastructure Model

Operations Management Model

Impact Analysis Summaries from Information, Process, Interfaces, and Operations Teams

Operations

1. Conduct a walkthrough meeting with representatives from the Information, Process, Interfaces, and Operations teams; applications and business unit stakeholders; and the Integration Test team. Present and walk through each physical model, as well as the Impact Analysis Summaries from each team.

2. Record any issues that arise.

3. Update the various models as issues are resolved.

4. Publish approved version of the models.

Work Product(s)

Approved Enterprise Physical Models

As part of enterprise infrastructure design activity area 480, the various components of the integration infrastructure are designed at a detailed level.

The Information team determines how data from one system is to be transformed into data that will be understood by the middleware and/or by other systems. This data transformation design is one input into the Integration Services Designs (developed by the Process and Interfaces teams). These designs describe the services required to process events through the middleware and between the middleware and the various applications or databases.

During integration services design activity 650, the components involving the middleware and its communication with applications and databases, usually through an interface, are designed. These designs may include specifications for code or configuration setup.

The Integration Services Design includes the following topics:

How events are to be routed between applications and interfaces

The integration logic, such as that involved in data transformation and object model processing

The interfaces between the middleware and each API and/or database

Messaging services required to pass events between the middleware and APIs or databases

Which components perform each of the above activities will vary depending on the middleware product being used.

The Integration Services Design will most likely include portions of deliverables that were developed as part of other activity areas, but are relevant to the component being designed. For example, the design may contain the relevant portion of the Physical Systems Interface model or the related set of physical process event flow diagrams.

Inputs

Enterprise Physical Process Model

Enterprise Physical Information Model

Enterprise Physical Systems Interface Model

Detailed Data Transformation Design information

Operations

Develop list of assumptions (to ensure validity of the design according to constraints and standards).

1. Determine/document the scope of the design (i.e., which part of the Enterprise Physical Process Model is covered by this design).

2. Determine which events are expected to be received (subscribed events) and routed by (published events) this integration component. For these events, refer to the associated events flow diagrams and event definitions that were developed as part of the Logical Model and Physical Model activity areas.

3. Determine data required to configure the component

4. Determine how the component should react upon a losing its connection.

5. Determine the type of storage used for different types of event, based on performance needs.

6. Reference any other events that are used by this component, but developed with a different component.

7. Define the specifications for processing by this component. Definition should be in the form of a flow chart at the pseudo-code level.

8. For each step in the processing of this component, document the data required (get this information from the Information team).

9. Determine any special error handling needs specific to this component.

10. Develop unit test cases and expected results. Unit test should generally be performed as a structural test and should thus use a “clear box” approach, in which all statements, branches, conditions, and/or paths are covered. Clear box unit tests are built based on the code itself.

11. However, some unit test cases are designed to verify system requirements; for these cases, a “black box” method is used. Black box unit tests are derived from the detailed design, and should include tests for both normal and exception processing.

12. Document the above using the template for the Detailed Design for Integration Services.

13. Review and validate the document with the development manager(s). The document should also be reviewed by a member of the Information team, to make sure that the data-related information was properly included in the design.

Repeat any of the above operations as necessary to develop an efficient and effective design.

14. Prepare and publish the final documentation according to engagement or client standards.

The work product for activity 650 is Detailed Design for Integration Services 655.

Data Transformation Design activity 660 provides a detailed description of how data is transformed at each step of each event flow.

The Data Transformation Design builds on the physical event definitions, adding more detail about the following:

Parsing rules

Attribute rules

Table lookups

Specific data values (for reference data only)

This information will be used as input to the Integration Services Design activity 650, which occurs concurrent to this activity.

Inputs

Enterprise Physical Information Model

Enterprise Logical Systems Interface Model

API information for each relevant application

Table information for each relevant database

Operations

For each application in the problem domain:

1. Document physical operations involved in translation (e.g., data is translated using a separated database, through a message broker, etc.).

2. Provide the Process and Interfaces teams with the data transformation information, so that those teams may add it to the appropriate

The Work Product of activity 660 is Detailed Data Transformation information 665.

During performance test plan activity 670, the Interfaces team develops the Performance Test Plan.

The Performance Test Plan provides firther details on performance testing, which was first described in the Enterprise Test Strategy. The plan contains the following information:

Detailed scope of performance testing: Because a single measure of system performance is not feasible, performance will most likely be measured as the aggregate performance of a clearly defined set of system functions. This set will contain those components that were developed specifically for the current project, and will not include COTS applications being integrated.

Agreed performance requirements and types of performance measures (such as response time or throughput) that will be taken. This information should be available in the service levels portion of the Operations Management Model prepared by the Operations team as part of the Enterprise Physical Model activity area.

A list of factors that could affect performance. These could include factors such as the middleware implementation or client business volumes.

Inputs

Physical Systems Interface Model

Operations Management Model

Operations

1. Identify stakeholders, such as area managers and SMEs. These are the people that are needed to support the planning and execution of the Performance Test.

2. Collect any existing information on performance and performance testing. This would include the service levels portion of the Operations Management Model.

3. Conduct interviews and/or meetings with stakeholder managers and SMEs to review the performance measures and targets that were agreed in developing the Operations Management Model (part of the Enterprise Physical Model activity area).

4. Conduct interviews and/or meetings with stakeholder managers and SMEs to determine the scope of performance testing, i.e., determine the set of system functions whose performance will be measured and aggregated.

5. Conduct interviews and/or meetings with stakeholder managers and SMEs to brainstorm on the various factors that may affect system performance.

6. Review and validate the document with the relevant managers and SMEs. Repeat the above operations as necessary to develop a complete and accurate Performance Test Plan.

7. Conduct handoff meetings as necessary with other people or teams that will be required to execute or support, or will otherwise be affected by, the performance test. Walk through the Performance Test Plan, emphasizing the role of each team, the testing schedule, and testing dependencies.

8. Prepare and publish the final documentation according to engagement or client standards.

The Work Product of activity 670 is Performance Test Plan 675.

While the other teams are involved in design of the integration infrastructure, the Operations team performs the installation and configuration of the development and production environments, and also develops a production readiness test plan during operations installation/configuration activity 680.

Installation and configuration should happen as early as possible during enterprise infrastructure design activity area 410, so that developers have a “play” area in which to try out design ideas.

The production readiness test plan documents the approach for, and measures of success of, the production readiness test. The test takes place as part of the enterprise integration test activity area 500 and covers areas such as:

Job streams run by system operators

Background processes

Event monitoring and scheduling

Problem resolution procedures

Backup and restore procedures

Security

External interface connectivity

Physical interface connectivity

Configuration Management Procedures

Capacity Limits

Service Levels

Inputs

Operations Management Model

Operations

1. Perform installation and configuration of following in the development environment:

New hardware and network components

System management components (includes configuration management tools, job schedulers, tools for monitoring and reviewing system performance and resource usage)

New or updated packaged software

New or updated custom-developed software (if available/applicable)

Backup and recovery jobs

2. Perform installation and configuration in the testing environment of the items listed above.

3. Perform installation and configuration the production environment of the items listed above.

4. Identify stakeholders, such as area managers and SMEs. These are the people that are needed to support the planning and execution of the Production Readiness Test.

5. Conduct interviews and/or meetings with stakeholder managers and SMEs to develop the production readiness test plan. Using the Production Readiness Checklist (part of the Operations Management Model) as input, decide on the measures of success for the test.

6. Review and validate the document with the relevant managers and SMEs.

7. Conduct handoff meetings as necessary with other people or teams that will be required to execute or support, or will otherwise be affected by, the production readiness test. Walk through the Production Readiness Test Plan, emphasizing the role of each team, the testing schedule, and testing dependencies.

8. Prepare and publish the final documentation according to engagement or client standards.

The Work Product of activity 680 is installed and configured development, testing and production environments, and Production Readiness Test Plan 685.

An Enterprise Integration Test Plan is produced at test plan activity 690 by the Integration Test team and is specifically about the Enterprise Integration Test. It does not include planning for other levels of test, such as unit test, string test, and performance test. Test plans for those test levels are produced by the responsible teams as part of other activities in this methodology.

Integration test focuses on how all the applications work together functionally. The approach for integration test will be referred to as “end to end” testing. The tests will test real business situations that map to a targeted set of functions and data. The Integration Test team will work with the Information, Process and Interfaces teams to identify logical groups of data to be selected for targeted testing.

The Enterprise Integration Test Plan covers many of the same topics as the Enterprise Test Strategy, but at a lower level of detail. It contains the following:

Scope of testing

List/outline of all test scenarios, scripts, and cases

Execution plan, which includes:

Location

Milestones (dates)

Environment

Schedule

Plan for coordinating testing of new or changed business processes with OD/CM team

Plan for coordinating test of external interfaces with outside vendors or client organizations outside the EAI project

Testing resources (staffing)

Incident management guidelines

Status reporting guidelines

Guidelines for turnover to the next activity area (i.e., production readiness test or acceptance test)

The test scenarios, and the schedule for executing them, should be planned such that those that test basic, yet representative, functions are executed first. This will allow the testers to test the stability of the integration infrastructure and the test environment, before more complicated scenarios are run. (Included in these more complicated scenarios are those that involve an external interface).

Other activities that take place during test plan activity 690 involve advance preparation for testing activities. These include training testers in the functionality of the applications and the middleware, as well as advance coordination with external parties in testing external interfaces.

Inputs

Enterprise Test Strategy

Enterprise Logical Process Event Model

Enterprise Physical Process Event Model

Enterprise Physical Information Model

Enterprise Physical Systems Interface Model

Operations Management Model

Operations

1. Conduct meetings with stakeholder managers and SMEs to decide on the scope of testing. The scope will likely be at least partly dictated by the statement of work for the project. The specific group of functions that should be included in Integration Test can be found in the Enterprise Logical Process Event Model.

2. Start making advance arrangement with external parties to test external interfaces. These arrangements should be made as early as possible.Arrange for training of testers on the enterprise applications, any new COTS applications and/or the middleware.

3. Involve OD/CM team in planning test of new or changed business processes as part of Integration Test.

4. Develop the list of all test scenarios, scripts, and cases. One can use either a top-down approach (scenarios defined first) or a bottom-up approach (test conditions defined first, then grouped into scenarios).

5. Conduct meetings with stakeholder managers and SMEs to decide on the test location and the specific dates that test execution, as well as the remaining test planning, will take place.

6. Conduct meetings with stakeholder managers and SMEs to develop a detailed testing schedule that specifies when each scenario and script will be run and in what environment.

7. Conduct meetings with stakeholder managers and SMEs to determine how many people (AMS or client) will be taking part in test planning or execution.

8. Conduct meetings with stakeholder managers and SMEs to develop other test guidelines and procedures, including:

Detailed guidelines for incident management and test case management.

Develop detailed guidelines for reporting status of test cases.

Guidelines for turnover from Integration Test to the next activity area (i.e., the Production Turnover and Infrastructure Installation activities within the Enterprise Infrastructure Implementation activity area)

10. Review and validate the document with the relevant managers and SMEs. Repeat the above operations as necessary to develop a complete and accurate Integration Test Plan.

11. Conduct handoff meetings as necessary with other people or teams that will be required to support, or will otherwise be affected by, the integration test. Walk through the Integration Test Plan, emphasizing the role of each team, the testing schedule, and testing dependencies.

12. Prepare and publish the final documentation according to engagement or client standards.

The Work Product of activity 690 is Enterprise Integration Test Plan 695.

As part of Enterprise infrastructure assembly activity area 420, the Information, Process and Interfaces teams all join to assemble, unit test, and string test the various components of the integration infrastructure. The integration infrastructure includes routing functions, rules, data transformation, API interfaces, database interfaces, and messaging services.

Assembly of these components may involve coding, setting simple or complex parameters, or using automated fourth-generation tools in order to set up the middleware to work between the various applications.

While the Information, Process and Interfaces teams are building, unit testing and string testing integration components, the Integration Test team is preparing for Integration Test and Performance Test. This preparation includes the development of scenarios, scripts, cases, and expected results.

The development of operations procedures also takes place as part of activity area 420.

During build/test integration services activity 700, the integration components are coded or configured, unit tested, and string tested.

A unit test is an individual test of the component(s) in each detailed design document.

A string test is test across multiple components. The purpose of the string test is to ensure the integration of each of various components through the middleware. It is intended to be a technical connectivity test that validates the flow of events and transactions from one application to the next.

There will most likely be some components that send output to an external interface, that is, an application outside the EAI project or even outside the client organization (such as a credit card payment processing company). These interfaces may be unit-tested (using stubs), but will most likely not be able to be string tested during this stage.

Inputs

Detailed Designs for Integration Services, including detailed data transformation information 665, and detailed design for integration services 655.

Operations

1. Partition development work

2. Write code with comments, documentation

3. Set up configuration parameters

4. Create new events

5. Update code to handle any new events

6. Run unit tests and record results. Develop drivers and stubs as needed. These should be used only when required external components are not available or make testing difficult (e.g., it is difficult to generate boundary values from the external component).

7. Conduct string tests across more than one component.

8. Review results of work with the development manager(s).

9. Prepare and publish the final documentation according to engagement or client standards.

The Work Product of activity 700 is Coded/configured Integration

Integration Components

Unit Test Results

String Test Results

During develop operations procedures 710, while other teams are involved in the coding, setup and testing of integration components, the Operations team develops operations procedures that will be used when the integration infrastructure is in production.

In addition to developing the operations procedures, the Operations team also revisits the Production Readiness Checklist, updating and refining it based on knowledge gained since the checklist was first developed.

Inputs

Operations Architecture document

Operations Management Model

Production Readiness Checklist

Production Readiness Test Plan

Operations

1. Work with the operations staff to develop the detailed procedures necessary for measuring the service levels agreed with the client. These procedures should build on the Service Level Measurement Tools and Procedures developed in enterprise infrastructure design activity area 410.

2. Work with the operations staff to develop other operations policies and procedures in areas such as:

Backups and restores (what should be backed up, how often, and what procedures should be followed)

Detailed security policies (building on security needs documented in Operations Management Model)

Archiving policies and procedures

Emergency procedures for system breakdown, including a problem escalation hierarchy

Manual business procedures that can be used if system breaks down (e.g., paper forms are used to record customer orders; data is keyed into system after recovery)

Procedures for problem reporting

Process for providing support to the application help desk

3. Review and validate the procedures and the checklist with the relevant operations staff, managers and SMEs. Repeat the above operations as necessary to develop a clear and effective set of Operations Policies and Procedures, and a complete Production Readiness Checklist.

4. Conduct handoff meetings with operations staff. Walk through the new operations procedures.

5. Prepare and publish the final documentation according to engagement or client standards.

The Work Product of activity 710 is Operations Policies and Procedures and Updated Production Readiness Checklist 715.

During test scenarios activity 720, the Integration Test team builds test scenarios, scripts and cases. These include scenarios, scripts and cases for Performance Test. The Interfaces Team should assist the Integration Test team with the performance testing materials.

As mentioned in the previous activity area, the test scenarios should be written such that those that test basic, yet representative, functions are executed first. This will allow the testers to confirm the stability of the integration infrastructure and the test environment, before more complicated scenarios are run.

Inputs

Enterprise Test Strategy

Enterprise Integration Test Plan

Performance Test Plan

Requirements

Operations

1. Develop each scenario that is listed in the Enterprise Integration Test Plan. A scenario should include:

Description (should include functions tested by scenario)

List of scripts grouped within this scenario

Components tested by this scenario

Business processes tested by this scenario

Prerequisites (general setup)

Related requirements or specifications, by script

Overview of reference data used in scenarios

Instructions on how to create data for the scenario, set up input, and execute major processes used in the scenario

2. Develop each script in each scenario. A script should contain:

Prerequisite setup that is specific to the script

Execution instructions that are specific to the script

Instructions on how to set up various forms of input (such as files, GUI input, etc.) required to run the script

List of various forms of output (files, table dumps, online query output, etc.)

3. Develop each case in each script. A case should contain:

Description

List of customers (or other major data entities) being run

Specific reference data values

Events used

Functional areas being tested

List of related cases

Setup and execution instructions specific to this case

Expected results

4. Review and validate documents with managers and SMEs. Repeat above operations as necessary.

5. Prepare and publish the final documentation according to engagement or client standards.

6. Deliver copies of the Integration and Performance test scenarios, scripts and cases to the application development teams. If necessary, conduct a handoff/walkthrough meeting.

The Work Product of activity 720 is

Integration Test scenarios, scripts and cases 725 and

Performance Test scenarios, scripts and cases.

As part of Enterprise integration test activity area 500, the various components of the integration infrastructure are tested together. The integration infrastructure is tested using the various applications.

It is not the purpose of activity area 500 to test the functional requirements of the applications being integrated. Rather, the purpose is to test the integration components to ensure they meet with integration business objectives.

However, in order to initiate the integration test and ensure the integration produces the desired results, the applications will be used to invoke and verify the integration test. In other words, the applications are essentially regression tested as a method to confirm the integration.

Performance testing and production readiness testing are also executed as part of activity area 500.

During integration test execution activity 750, the Integration Test team does the necessary setup, then runs the integration test scenarios (using the enterprise applications) and validates results.

The test scenario execution should be scheduled such that those scenarios that test basic, yet representative, functions are executed first. This will allow the testers to confirm the stability of the integration infrastructure and the test environment, before more complicated scenarios are run.

Within these two groups of “basic” and “complicated” scripts, multiple scenarios can be executed simultaneously.

Included in the integration test are scenarios that test external interfaces. External interfaces involve output from the integration components that is sent to an application outside the EAI project, or even outside the client organization (such as a credit card payment processing company). These interfaces require advance coordination (see the Enterprise Integration Test Plan stage), but should not be included in integration test until the infrastructure is proven to be reasonably stable. Thus, the external interface scenarios should be run after the basic scenarios have been run.

Inputs

Integration Test scenarios, scripts, and cases

Integration Components

Operations

1. Perform the necessary setup as described in the test scenario and script documentation.

2. Execute each test case.

3. Document results. When results differ from expected results, enter an incident.

4. When incident is resolved, re-run test and/or update test case document (whichever is applicable).

5. Document final results in the test case document. Documentation of final results includes:

Notes on actual results

Name of person validating, date, time

Validation proof (reference to an event file generated by case, screen print of GUI, etc.)

6. Review results of work with the Integration Test manager(s).

7. Prepare and publish the final documentation according to engagement or client standards.

Work Product(s)

Executed integration test scenarios, scripts, and cases

During performance test execution activity 730, the Operations Test team sets up the necessary data, utilities, etc. for performance testing. The team then runs the scenarios and validates results.

Performance test execution involves a combination of manual and scripted processes.

Manual testing verifies the system's performance from the user's perspective. It consists of stepping through specially selected functions.

Scripting allows for the testing with high loads that would be infeasible to create manually. An example of scripting would be the use of a driver script that is used to generate high volumes of events through the middleware, creating a load on receiving applications. (These events should correspond to actual events that would be published by individual applications.)

Ideally, performance testing should be run after the basic set of integration test scenarios have been run, in order to make sure that the infrastructure is somewhat stable.

Inputs

Performance test scenarios, scripts, and cases

Performance Test Plan

Operations

1. Conduct a kickoff meeting to make sure that everyone understands his/her role in the Performance Test.

2. Set up the necessary data, utilities, etc.

3. Execute each test case.

4. Report and resolve incidents and issues as necessary.

5. Measure and record test results in the test case document. Documentation of final results includes:

Notes on actual results

Name of person validating, date, time

Validation proof

6. In validating each case, confirm that the associated performance service level(s), as agreed during the “Operations Management” stage, have been met. If they have, report this to the Operations team; they will check that item off on the Production Readiness Checklist. If the service level is not met, enter an incident and assign an owner to the problem.

7. Review results of work with the Performance Test manager(s).

8. Prepare and publish the final documentation according to engagement or client standards.

9. At the end of the test, immediately report any outstanding incidents. These issues should be escalate and/or resolved as quickly as possible.

Work Product(s)

Executed performance test scenarios, scripts, and cases.

Tested performance parameters/conditions 735.

During production readiness test execution activity 740, the Operations Test team sets up and executes the Production Readiness Test, using the production readiness test plan and the production readiness checklist as guides.

The production readiness test will determine whether or not the client's operations, organization, procedures are ready to go live with the new integration infrastructure. It is a test of the operations infrastructure and, just as importantly, of the procedures that the Operations team developed as part of enterprise infrastructure assembly activity area 490.

Ideally, production readiness testing should begin after the basic set of integration test scenarios have been run, in order to make sure that the infrastructure is somewhat stable.

Inputs

Production Readiness Test Plan

Production Readiness Checklist

Operations Procedures

Operations

1. Conduct a kickoff meeting to make sure that everyone understands his/her role in the Production Readiness Test.

2. Assess each area covered in the Production Readiness Checklist. This may include the following:

Confirming that software, hardware, and network components are installed

Checking connectivity with external interfaces

Running the job schedule, system monitoring tools

Testing the configuration management procedures

Testing backup and recovery procedures

Testing security

3. Compare the results of the assessment with the measures of success (from the Production Readiness Test plan). If the measures of success are met, check off the related items on the Production Readiness Checklist.

4. Record areas that need to be improved before the integration infrastructure can go live. Assign owners to each of these areas, and escalate if necessary.

5. Review results of work with the Production Readiness Test manager(s).

6. Prepare and publish the final documentation according to engagement or client standards.

The Work Product of activity 740 is tested production operations procedures 745.

As part of Enterprise infrastructure implementation activity area 440, the integration infrastructure components are installed and validated.

End user readiness test activity 760 is an informal, high level test that is meant to be an extra quality check, not a formal acceptance test.

During activity 760, end users use the enterprise applications to validate that the integration infrastructure (that connects the applications) is working. Users should run through several typical business scenarios to make sure that information is processed correctly through multiple systems.

An example of how this test might work would be to have volunteers (users or others in the organization) designated as the first “customers” of the new system. These volunteers would interact with the system end users, going through the normal operations involved in common business functions. For example, the volunteer may set up a new account, change customer information, incur charges, and receive a bill for those charges. The business functions that are included in the test should, of course, cross more than one application, in order to exercise the integration infrastructure.

Inputs

Complete production environment

Operations

1. Conduct a kickoff meeting to decide on the following:

Who participates in the test

Roles of participants

General range of business functions to be run

Measures of success

2. Execute the test. Record any problems as incidents. Escalate and/or resolve these incidents immediately.

Work Product(s)

Validated business functions and procedures

During infrastructure installation activity 770, the custom software components that support the integration infrastructure are installed. An installation test is run to confirm that all components were installed correctly.

User and operations documentation and training are also delivered during this stage.

As each activity is completed, the operations staff should check off all related items on the Production Readiness Checklist.

At the end of this stage, the installed infrastructure, and all associated procedures, should be ready to be put into use in the production environment.

Inputs

Tested Integration components

Tested performance parameters/conditions

Test Production Operations Procedures

User and operations documentation

User and operations training materials

Operations

1. Confirm that the components listed below were installed and configured in the production environment during the Operations Installation and Configuration stage.

New hardware and network components

System management components (includes configuration management tools, job schedulers, tools for monitoring and reviewing system performance and resource usage)

New or updated packaged software

New or updated custom-developed software (if available/applicable)

Backup and recovery jobs

2. Re-install and re-configure any components that have been updated since the Operations Installation and Configuration stage.

3. Run an installation test using a basic script(s) that executes all the installed components; an Integration Test script(s) could be used. The test should include a test of connections with external interfacing systems (both source and distribution). Also include the job scheduler and system monitoring tools in this test.

4. Define and implement access privileges for users and operations.

5. Test the configuration management procedures in the production environment (for example, moving a change between environments or backing out a change).

6. Finalize and deliver user and operations documentation. Store documentation in a central repository.

7. Schedule and conduct training for users and operations staff.

8. Confirm that the production staff is ready to take over responsibility of the system. They should be trained in new procedures and aware of the production turnover schedule.

9. Confirm that the technical support infrastructure (including support to the help desk for applications) is in place and ready.

10. Confirm that the problem reporting procedure is in place.

11. Confirm that the Production Readiness Checklist has been completed. Assign an owner to and immediately escalate any item that is incomplete.

Work Product(s)

Complete, installed production environment 775.

During production turnover activity 780, the operations staff does a final check of the Production Readiness Checklist is made. After the client signs off on the infrastructure, the integration environment is put into live operation. Responsibility for the integration infrastructure is turned over to the production organization.

Inputs

Complete, installed production environment

Completed Production Readiness Checklist

Operations Procedures

Operations

1. Conduct a production turnover meeting to review the whole Production Readiness Checklist. If there are any outstanding issues, these must be resolved before proceeding.

2. Obtain formal signoff on the delivered infrastructure.

3. Perform cutover (data starts to be run through the new infrastructure).

4. Formally turn over responsibility to the production organization.

Work Product(s)

Live integration infrastructure

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### Appendix

Activity

A major task within each activity area. Examples include Enterprise Process Domain Model, Physical Process Model, or Integration Services Design.

Activity Area

Grouping of activities within each EAI Methodology phase. There are one or more activity areas for each phase. Examples include the Enterprise Business Model and Enterprise Infrastructure Design activity areas.

Application Program Interface (API)

A predefined, structured interface through which other programs may communicate with an application.

Assembly

In the AMS EAI methodology refers to tasks involved in building the integration infrastructure; includes everything from software development through infrastructure tool setup.

Asynchronous communications

Communication between applications during which the applications operate independently. Thus the applications do not need to be simultaneously running/available. One application sends a request; this may be answered immediately, or it may be queued for later processing by the receiving application. In the meantime, the sending application can continue processing without waiting for the response.

Canonica

Generic or normative; following or providing a standard, as in a canonical data model.

Information thread

The full life-cycle set of activities in the EAI methodology that relate to information. While data is defined as the numbers or other symbols represented in a form suitable for processing by a computer system, information can be defined as stimuli that has meaning in some context for its receiver. Information is converted into data, put into a system or application where it is stored and processed, and then put out in some form that can be perceived as information. This translation from information into data and back into information is in fact one of the major challenges of integrating different applications. The EAI Methodology addresses the issue through the Enterprise Information Domain model, which provides a common context in which to interpret data originating from different sources and different systems.

Data-level integration

A form of EAI that integrates different data stores to allow the sharing of information among applications. With this type of integration, data is loaded directly into a database through its existing interface. This does not involve the changing of business logic.

Data transformation

Translation of one data set into another, such as different date or number formats (syntactic translation) or translation of data based on the underlying data definitions or meaning (semantic transformation). This is a key function of EAI and message brokers.

Enterprise Application Integration (EAI)

A set of technologies that allows the sharing of information between disparate enterprise applications and business processes. EAI uses a systematic process to tie together applications and processes within and between organizations.

Integration Test

Concerned with testing the integration infrastructure and the end-to-end interaction between application systems.

Interface thread

The full life-cycle set of activities in the EAI methodology that relate to the application interfaces and middleware infrastructure. An interface is the point of interaction or communication between an application system and any other application system or computer entity. An interface might be a hardware connector used to link to other devices, or it might be a convention used to allow communication between two application systems. Often there is some intermediate component(s) between two applications that connect their interfaces. In fact, in the case of EAI, there are by design a series of discrete physical interfaces; these together provide an end-to-end interface between any two interacting application components.

Message broker

A flexible, intelligent intermediary that manages the flow of messages between applications. Such brokers provide data transformation, message routing and message warehousing, as well as other services. Applications become sources (publishers) and consumers (subscribers) of information. A message broker is a key component of EAI.

Middleware

Software that facilitates the communication between two separate, existing applications. It provides an API through which applications invoke services and it controls the transmission of the data exchange over the network.

Model

An abstraction of one or more systems that gives information about the data, processes, interfaces, etc. involved, usually in a graphical format. Graphics may be supplemented by other material.

Non-invasive integration

An implementation approach that does not require software programming updates to existing integration applications.

Operations thread

The full life-cycle set of activities in the EAI methodology that relate to operations including management of the middleware environment. It includes hardware, network, and software components, but is specifically focused on the middleware (enterprise-wide) layer, as opposed to the application (departmental) layer. Management refers to planning, controlling, monitoring, reporting, correcting and changing the middleware environment. The same management guidelines that apply to application and system operations apply to middleware operations, but at a different level. For example, the service levels required of the middleware will be based on the enterprise-wide aggregate service levels. There are also planning and change management needs associated with the middleware itself.

Phases

Refers to the highest level of aggregation of activities within an EAI methodology project. The five phases are Define, Design, Build, Test and Deploy.

Process automation

Sometimes referred to as “workflow”, process automation involves the management of the movement of data and the invocation of processes in the correct and proper order in an automated fashion using pre-programmed and dynamic software tools. Process automation at the enterprise level provides another layer of centrally managed processes that exist on top of an existing set of application processes and data.

Process thread

The full life-cycle set of activities in the EAI methodology that relate to the process tasks including a logical ordering of people, technology, policies, and procedures into a coordinated set of activities. These activities are designed to transform information into a specified result, in order to meet business objectives. The EAI Methodology is concerned with the processes that are relevant across the enterprise, that is, between departments and across systems.

Publish/subscribe

A type of communication between applications. Publishing applications are able to broadcast data to hub, which distributes the information to the set of interested subscribers. Subscribing applications have indicated which types of information they wish to receive. An application can be both a publisher and a subscriber.

Specification

Refers to the inputs to the EAI process. Used instead of “requirements.”

Synchronous communications

A form of communication between applications that requires the applications to run simultaneously. A process issues a call and waits until it receives a response.

Threads

Common integration aspects that weave through some or all EAI methodology phases. Examples are the Data, Process, Infrastructure and Operations threads.

Workflow

The sequence of human and system activities that describe what an organization does and in what order at the worker level. Usually refers to the activities within a given application system and typically only when human activities are involved. See also process automation.

Zero latency

Another term for “real time;” the case in which there is no delay between an event and its response.

What is claimed is:

1. A method for integrating business functions performed by different application systems, comprising:
generating a business model, based upon said application systems;
generating a logical model, based upon said business model;
generating a physical model, based upon said logical model;
designing an infrastructure, based upon said physical model;
assembling the infrastructure;
testing the infrastructure; and
implementing the infrastructure.

2. The method for integrating business functions performed by different application systems according to claim 1, wherein said business model comprises:
a process domain model;
a information domain model;
a system infrastructure model; and
an operations model.

3. The method for integrating business functions performed by different application systems according to claim 1, wherein said logical model comprises:
a logical process event model;
a logical data model;
a logical infrastructure model; and
an operations architecture.

4. The method integrating business functions performed by different application systems according to claim 1, wherein said physical model comprises:
a physical process event model;
a physical data model;
a physical infrastructure model;
an operations management model; and
a test strategy.

5. The method integrating business functions performed by different application systems according to claim 1, wherein designing an infrastructure comprises:
generating an integration services design;
generating a data transformation design;
generating a performance test plan;
generating a production readiness test plan; and
generating an integration test plan.

6. The method for integrating business functions perform-ed by different application systems according to claim 1, wherein assembling the infrastructure comprises:
building and testing integration components;
developing operations procedures; and
building test scenarios, scripts and cases.

7. The method for integrating business functions performed by different application systems according to claim 1, wherein testing the infrastructure comprises:
executing integration test scenarios;
executing performance test scenarios; and
testing production operations.

8. The method for integrating business functions performed by different application systems according to claim 1, wherein implementing the infrastructure comprises:
validating the infrastructure;
installing the infrastructure; and
operating the infrastructure.

9. A method for integrating business functions performed by different application systems, comprising:
implementing business applications; and
integrating the implemented business applications by using a framework to consistently divide integration tasks into smaller manageable integration tasks.

10. The method for integrating business functions performed by different applications systems according to claim 9, wherein said implementing business applications and said integrating the implemented business applications are separate and distinct operations.

11. The method for integrating business functions performed by different applications systems according to claim 9, wherein the framework comprises different layers, subject threads, and modeling views.

12. A method for integrating business functions performed by different applications systems according to claim 11, wherein the layers are represented using modeling techniques.

13. The method for integrating business functions performed by different application systems according to claim 12, wherein the modeling techniques comprise:
gathering specifications of items to be integrated;
modeling functions and/or behavior of the items;
mapping connections between systems; and
developing integration principles to resolve integration conflicts.

14. The method for integrating business functions performed by different application systems according to claim 9, wherein said implementing business applications and said integrating the implemented business applications have different lifecycles.

15. A repeatable EAI lifecycle methodology, comprising:
integrating enterprise application systems;
maintaining the integrated enterprise application systems;
modifying the integrated enterprise application systems; and
expanding the integrated enterprise application systems.
